(19) United States
(12) Patent Application Publication
(10) Pub. No.: US 2012/0290420 A1
(43) Pub. Date: Nov. 15, 2012

(54) Secure Payment Terminal

(75) Inventor: Paul Close, Tigard, OR (US)

(73) Assignee: Advanced Payment Terminal Corporation, Hauppauge, NY (US)

(21) Appl. No.: 13/575,053

(22) PCT Filed: Jan. 27, 2011
(86) PCT No.: PCT/US11/22742

§ 371 Date: Jul. 25, 2012

Related U.S. Application Data
(60) Provisional application No. 61/299,169, filed on Jan. 28, 2010.

(51) Int. Cl. G06Q 20/40; G06Q 20/34; G06Q 20/20

(52) U.S. Cl. 705/17; 705/16; 705/24; 705/18

(57) ABSTRACT

Exemplary embodiments include a payment terminal, with corresponding methods, and computer-readable media, which includes a first interface and a second interface. The first interface receives transaction information from an existing interface of a sales device without modification to the sales device. The first interface also transmits first authorization information to the existing interface without requiring modification to the sales device, thereby enabling the sales device to monitor and authorize a transaction associated with the sales device. The second interface transmits authorization request information associated with the transaction to a payment authorization system. The authorization request information represents the payment information. The second interface receives authorization response information associated with the transaction from the payment authorization system. The first authorization information is based on the authorization response information, and the first authorization information does not include the payment information.

### CROSS-REFERENCE TO RELATED APPLICATION

This application claims the benefit of U.S. Provisional Application No. 60/299,169 filed Jan. 28, 2010, which is incorporated herein by reference in its entirety.

### BACKGROUND

1. Technical Field

Embodiments disclosed herein are directed to a system to simplify the integration of electronic and other non-cash payments into a sales checkout process of smaller retailers and to speed customer service while reducing fees and other costs of non-cash payment acceptance.

2. Brief Description of the Related Art

Relevant fields include several disparate industries, including those that supply devices used to enter sales and/or non-cash payments at a retail point-of-sale and other points of payment for goods and services including, but not limited to: (1) POS (point-of-sale) cash registers, (2) ECR (electronic cash registers), (3) countertop or standbeside (electronic payment devices), (4) acquirers of transactions from merchants, (5) processors of electronic payments, (6) networks such as SPN (secure payment network) that transmit electronic payment transactions between acquirers, processors, and associations, card issuers, and (7) processors that acquire transactions from retailers and acquirers and forward them to the associations (such as Visa®, MasterCard®, Amex®, and the like) and that may also maintain the accounts for various issuing institutions. Non-cash payments may include: checks, coupons, credit cards, debit cards, EBT (electronic benefit transfer) cards, stored value (also known as prepaid or Gift) cards. These cards may include standard ISO (International Organization for Standardization) magnetic stripe cards carrying a customer identification number and other information; so-called “smart cards” or EMV (expected monetary value) cards with a computer chip and memory; and contactless RFID (Radio Frequency Identification) media embedded in or attached to cards, devices or items such as key fobs, cell phones and bar codes. Any of these may be used in conjunction with or without a PIN (personal identification number) or biometric information that may be verified either by logic within the card or by access to an external source.

An SRD (sales recording device) may be a cash register or a computer used to perform cash register functions. The cash register was invented in the late 1800's to ensure that the retailer received all the money due from the sale of merchandise and allowed the customer or merchant to audit that the correct amount was recorded. A cash register adds up the items in a transaction and has a customer display that allows the customer to verify that the amount entered was correct. Later, a printer was added to produce customer receipts and a permanent printed record of transactions (usually referred to as a “journal”) for the retailer. An important feature of a cash register is that a fixed register number and consecutive non-resettable number is assigned to each transaction, which along with a date and store identification, relate a receipt and journal together and to the specific SRD and transaction. Together (the date, store, register, and transaction) they uniquely identify each transaction.

The SRD (sales device or cash register) establishes basic control over the transaction including both cash and non-cash payments. The SPT may take over some of the variety of electronic payments starting with control established by the SRD.

Although there were several earlier experiments, the first systems to capture detailed sales data were actually electro-mechanical cash registers that did not communicate but created punched paper tape or optically readable journals for courier delivery to a data center for subsequent processing. Next came electro-mechanical devices at the POS (point of sale) that communicated all entries in a transaction via telephone lines to a central computer in real time, and also provided on-line authorization of manually keyed account numbers for private label credit cards. These early POS were first installed in 1965 and were used for over ten years before being replaced by electronic POS. The electronic POS, first introduced in 1970 after some failures, came to be known by a variety of acronyms including POS (point-of-sale), POST (point-of-sale terminal), and EPOS (electronic point-of-sale). Later, PC's (personal computers) were converted into POS. These were sometimes called PC-POS because they had a PC processor, while many were simply PC equipped (sometimes called “pieces 'n parts”) with a cash drawer, receipt printer, customer display and other peripherals required at the POS. All electronic POS and ECRs (electronic cash registers) are considered to be SRD (Sales Recording Devices) as referred to herein.

The first electronic cash registers were POS terminals designed for large chain stores. They had electronic rather than mechanical logic and accumulators but functionally did little more than their EMCR (electro-mechanical cash register) predecessors, including: automatic tax calculation, multiplication when several identical items were entered, percentage discounts and cash change computation. The important difference was that they captured the detail of each transaction—in the register—or in an electronic tape recorder attached to the register, or in a computer in the backroom of the store or in a remote host computer. The data was then transmitted as what came to be known as a “transaction log” for processing by a remote computer (usually located at a central office) that could consolidate the information from a number of registers and stores. The early POS could also enter a customer's account number, generally manually entered, that could be check digit verified by the POS or another device later in the process. This allowed the data to be used for on-line authorization and centralized computer billing. There were also experimental merchandise ticketing systems to automatically identify items of merchandise sold, but none were very successful. The next step was in supermarkets, when a bar-coded merchandise method, the UPC (universal product code) was developed and a barcode scanner added to the POS to scan a merchandise UPC bar code and lookup the price of that item. However, the supermarket POS did not capture the transaction detail, but instead only captured summary totals of each UPC scanned, either in the register or in a backroom server for the entire store. Another branch of POS evolution occurred in restaurant POS with the inclusion of a menu in the POS and development of touch-screen keyboards to enter extensive menus and modifiers that were required. The selection of items and details of each order were typically transmitted electronically to a kitchen printer or display to provide food orders.

While credit had long been extended by individual retailers, the necessity to carry cards for use with a specific retailer's systems and the complexity of maintaining a billing system made it too difficult and expensive for smaller retailers to sell on credit. The value of a single universally accepted card that could be used for non-cash payments became apparent. American Express and Bank of America introduced so-called general purpose credit cards that could be accepted for non-cash payments by almost any retail establishment. Initially, these cards were primarily accepted by airlines, hotels, restaurants, and smaller retailers. The BankAmericard® was renamed Visa® and taken over by an association of major banks Another “universal” bank card issuing association was formed as MasterCard®. American Express® and Diner's Club® were called T & E (travel and entertainment) cards and were introduced at about the same time. More recently, the Discover Card® was introduced as a competitor. All of these cards were accepted nationwide, now worldwide, but authorization and settlement with the card issuing entity was slow and expensive. A standard means of accepting the nationwide (now worldwide) bank-issued and T & E cards at the POS and then settling by submitting transactions to the card issuing entity was needed.

The new “general purpose” credit cards were first accepted at only travel services, such as airlines, hotels, restaurants, and small retailers because they were issued and processed by local banks The larger retailers had long had their own private label cards and billing systems and were concerned that the cost of accepting the universal cards was too high and the incremental sales not sufficient to justify their acceptance. They also had machine readable credit cards (mostly using punched holes or relying on manual entry of account numbers into POS registers) and on-line authorization systems. Some experimental bar code and magnetic stripe systems were tried but all retailers finally adopted the industry standard magnetic stripe system.

Two primary roadblock to getting large stores and chains to accept the new “universal” credit cards were: (1) fear that the universal cards would simply displace their own proprietary card business, and (2) that they must be able to capture payments through the POS without a separate standbeside terminal, that is, the card entry must be “integrated” into their POS system without any extra terminals or manual copying of amounts as performed by the small retailers. JC Penney® was the first major chain to do so; manually keying the general purpose card account numbers into their existing POS so they were verified for validity (using check digit verification) and on-line authorization (just like the private label cards) and included in the store's POS generated receipts. It took many years for some stores to integrate electronic payments into their POS because the POS couldn't be modified to accept longer bankcard account numbers; so they had to wait until they could replace the POS. The difficulty in changing the ECR has continued to be a major obstacle to integration that is overcome by the embodiments disclosed herein.

After experiments by Bank of America®, Citibank®, American Express®, and others; Visa® specified a device for small retailer's (originally called a CAT (Credit Authorization Terminal)) which was placed next to the retailer's cash register. The CAT had an MSR (magnetic stripe reader) and dialed a central computer when a standard ISO magnetic stripe card was swiped through the card reader by the cashier and a transaction amount and transaction type (such as sale, return, or void) was manually entered. The device dialed using the POTS (Plain Old Telephone System) for authorization. Although recent models transmit via the Internet, most smaller retailers still use the less expensive and ubiquitous dial telephone network until their volume reaches a level at which the faster, but more expensive, less reliable, and less-secure Internet-based communication link is used for authorization. While these terminals were referred to as CATs at that time, more recently, these terminals are referred to as “standbeside” or “countertop” terminals, since the acronym “CAT” began to be used to refer to customer activated terminals developed for larger retailers. The standbeside terminals that are placed next to, but not attached to, or integrated with the cash register, improved the accuracy of transaction amount recording, and provided more legible customer receipts. The standbeside terminal enabled card issuers to achieve zero floor limit authorization (i.e., on-line authorization of all transactions) and eliminated (1) the tedious and unreliable in-store process of manual checking against a printed hot list of non-acceptable cards by the cashier for authorization, followed by (2) a costly and slow process of handwriting separate multi-part paper receipts, and (3) imprinting the customer account number by using an embossed card machine (often called a “knuckle-buster) that, when the embossed card and a multi-part carbon form are inserted, is still used today as a backup when electronic authorization is unavailable. This system also eliminated the need to move paper copies to the bank that would then key-enter the information. Surprisingly, the use of a CAT for on-line authorization made little improvement in the checkout speed at the point-of-sale. However, it did allow the bank issuers and the card associations to charge lower rates (so-called interchange) because it provided zero floor limit on-line authorization, automatic transaction capture, better accuracy, and faster detection of fraud and unusual activity.

Card issuers and retailers adopted the standard ISO magnetic stripe card format so the cards could be accepted by one device at every retailer's POS. While the device was originally called a CAT (credit authorization terminal), that acronym was abandoned in favor of the more sophisticated POS, which then introduced more confusion because the same POS acronym was used to identify the electronic POS cash registers in larger retail stores. Some of this confusion persisted as the electronic payment terminal industry continued for some time to use the acronym POS when referring to standbeside terminals. Standbeside terminals are not attached to a POS or ECR, the latter of which are the predominant type of cash register used in smaller retailers. More recently, standbeside terminals have been referred to as just “standbeside by the cash register industry, and countertop by the payment industry.

Another iteration was introduced by the advent of PIN debit requiring a PIN entry, which was first done with a small keyboard attached to a POS (not an ECR) specifically for entry of a PIN by supermarket customers. Some in the electronic payment terminal industry call almost any terminal a PIN pad if it can receive, encrypt, and pass a customer's PIN for verification.

Originally, the standbeside CAT did not have a printer. However, soon printers were added that produced a printed draft and receipt of the total amount of the sale, thereby eliminating the need for a hand-written multi-part form. When an approval response is received, two documents are printed: the customer signs the original “draft” for retention by the store in the event of chargebacks, and the customer receives a copy along with (in most cases) the cash register receipt with transaction detail. Card transactions are usually accumulated in the standbeside terminal and a remote authorization computer for balancing and reconciliation. Current terminals have a more streamlined form and functions have been added for special types of transactions, but the process at the point-of-sale has functionally been little changed in over twenty-five years since the CAT with EDC was first introduced.

Originally, each issuing bank (or their correspondent bank) processed their own credit card accounts. However, this was too expensive for most banks, and limited the geographic area where they could issue cards. Therefore, in the late 1980s, a new industry, which might be called the electronic payment (card processing) Industry, evolved to provide more efficiency of scale than individual banks could. This industry (hereinafter referred to as processors) enabled banks to extend the reach of their credit cards and to market them to customers and retailers nationwide.

The early POS industry was dominated by large cash register manufacturers, such as NCR and SWEDA, but also included new companies such as Singer, Pitney-Bowes/Alpex, National Semiconductor (Data Checker), and MICROS. These companies introduced POS systems for large multi-store chains, and were eventually joined by IBM, Fujitsu, ICL, and others. The multi-store chains with larger multi-register stores took the lead followed by growing specialty chains with smaller stores and high volume. These stores could afford the high initial cost and ongoing maintenance of POS with electronic payments integrated therein.

However, most smaller retailers could not afford the expensive POS (which collected data for analysis) and used ECRs with the non-connected (standbeside) terminals, which are slow and prone to error (because the merchant must complete the transaction, then swipe the card, manually enter the amount into the standbeside and wait for it to dial to a processor for authorization). A Standbeside does not necessarily accept PIN debit cards but a separate PIN pad may be attached so the standbeside can be operated by the cashier and the PIN pad handed to the customer when a PIN is required. Standbesides are still used in the vast majority of smaller stores and the separate PIN pad is used in smaller stores that can capture PIN—despite the growth of PC's in a few store types, such as laundry/dry cleaners, higher-end bar restaurants and smaller supermarkets with specialized systems.

High-volume supermarkets with front-end checkout systems found that acceptance of ATM (debit) cards reduced the number of checks accepted at the point-of-sale. Checks were slow and expensive to handle; but they were the predominant method of payment for food and every day necessities. Therefore, large supermarkets began to add PIN pads to their POS (registers) to accept ATM cards because the costs were less than the cost of accepting checks. However, supermarkets did not accept credit cards because the interchange cost was too high.

The bank credit card associations (led by Visa®) determined that bad debt costs from supermarket credit card transactions were lower than for other types of stores, and introduced the so-called “Check Card” (Visa®) and “Money Card” (MasterCard®) which were debit cards that could be used at the POS with a PIN. These cards carried lower interchange rates for debit with PIN. They could also be accepted without PIN, at a lower interchange rate than credit cards, but higher than when used with PIN. The lower credit card interchange rates for supermarkets broke the impasse and supermarkets began to accept all bank cards whether credit or debit (i.e., check cards and money cards) at the POS. This quickly began to reduce check use in supermarkets and some have even stopped taking checks. The check/money cards were physically and logically identical to credit cards so the consumer could use them (without PIN) at any store that accepted credit cards and they could also be used (with PIN) at ATMs to withdraw cash.

However, the supermarkets discovered that the growing card acceptance slowed checkout since the cashier had to wait until the sale was completely entered and then take the card from the customer and ask them if it was debit or credit. The cashier then entered a debit or credit key, and swiped the card at the POS that then transmitted the card number and amount to a remote SPC (secure processing center) for authorization. The question is actually not precise, and if the card was a credit card and so identified by the customer, it was authorized as such. If the customer answered “debit”, then the cashier asked the customer to enter their PIN and handed the customer a PIN pad. The confusion arose when the customer wanted the card to be accepted like a credit card (i.e., without PIN), in which case it was so designated at the POS, and the remote SPC included it with the credit cards settled with either Visa® or MasterCard®. This was confusing because the customer did not have a corresponding credit account, but only knew that if they answered “credit” they got an extra day's float. This was awkward and slow because the magnetic card reader and PIN pad were integrated with (i.e., attached to) the POS register so the cashier had to finish ringing the sale then switch to asking the customer if they wanted to pay by card, and if so was it a debit or credit. Only after that process and swiping by the cashier could the authorization and printing of documents take place. So a new type of system was developed; called the MLS (multi-lane-system) and with what has come to be called the CAT (customer activated terminal). The CAT is customer-facing and the customer activates it by swiping their card and starting a customer dialogue identifying the card as debit or credit and entering the PIN (with debit). At first, the developers didn't quite get it right, holding up the process while the cashier was busy ringing the sale; at which time the customer could swipe their card, identify it as debit or credit, and enter PIN with debit. In supermarkets, transactions average about 20 items and so there is time while the cashier finishes bagging for the customer to activate the CAT, which shortens the checkout process.

In spite of the conflict with the term CAT used to identify the original “standbeside terminals used by smaller retailers the new customer activated terminals became known as CATs and the older standbesides became better known, in the payments industry as countertops, and in the cash register industry as standbesides. The acronym CAT (customer-activated terminal) is used herein. So, while the old credit authorization terminal designation has disappeared in favor of “countertop” or “standbeside”, the MLS acronym is used herein to identify the system used in larger retailers and chains using CATs. The MLS system was at first controlled by a separate backroom computer that communicated with the POS backroom computer while the CATs communicated with the MLS computer. More recently, CATs have been interfaced directly to the POS. Either way, the POS system has all the data and handles all communications for authorization and settlement of transactions. The CAT leads a customer through the process of swiping the card, identifying whether it is debit, credit, gift EBT, or other card, then asking for a PIN if the customer responds with it being a debit. Then, the CAT is instructed by the POS that sends the sale amount to the CAT, to prompt for approval of the sale amount by the customer and, when that is approved, the card data is sent to the SRD and the SPS via the POS register and the POS communication system to be authorized. The SRD system then handles the communication and interaction with a processor and the associations and/or issuers.

### SUMMARY

In one embodiment a payment terminal is provided, which includes a first interface and a second interface. The first interface is configured to receive transaction information from an existing interface associated with a sales device without modification to the sales device. The first interface is configured to transmit first authorization information to the existing interface associated with the sales device without requiring modification to the sales device, thereby enabling the sales device to monitor and authorize a transaction associated with the sales device. The second interface is configured to transmit authorization request information associated with the transaction to a payment authorization system. The authorization request information represents the payment information associated with a customer. The second interface is configured to receive authorization response information associated with the transaction from the payment authorization system. The first authorization information is based on the authorization response information, and the first authorization information does not include the payment information.

The existing interface associated with the sales device may include at least one of a (1) printer port, (2) journal port, and (3) digital video port. At least one of the (1) first interface and (2) second interface may be a wireless interface. The payment terminal may initiate communication with the payment authorization system in response to at least one of (1) initiation of the transaction on the sales device and (2) termination of a delay following initiation of the transaction on the sales device. The payment terminal may maintain a communication link with the payment authorization system until at least one of (1) the payment terminal receives the authorization response information, (2) the transaction is terminated, and (3) a timeout period. At least one of (1) the first interface and (2) the second interface may include at least one of a (1) magnetic stripe card reader, (2) magnetic card scanner, (3) printer, and (4) printer port. The payment terminal may be configured to activate a printer associated with the sales device, and may include a display configured to display the transaction information. The payment terminal may be configured to store the transaction information in a transaction log and transmit the transaction log in response to at least one of the (1) first interface and (2) second interface being idle.

The payment terminal may be configured to encrypt the payment information and identification information associated with the payment terminal, and transmit the encrypted information for authentication of the payment terminal. The authorization request information may not include secure information associated with the customer, wherein the secure information includes at least one of a (1) PIN (personal identification number) and (2) payment card number. The authorization request information may include four (4) low-order digits of an account number associated with the customer. The payment terminal may use a plurality of bank identification numbers to determine a type of card associated with the transaction, wherein the plurality of bank identification numbers is associated with cards used in transactions on the payment terminal for which the type of card has been approved, thereby eliminating a need to query the customer to identify the type of card being used in the transaction. The payment terminal may be configured to identify the transaction as a signature debit transaction by comparing an amount associated with the transaction to a predetermined transaction amount threshold associated with a type of card. The payment terminal may be configured to query the customer to enter a PIN (personal identification number) based on an amount of the transaction, and the payment terminal may enable the customer to opt-out of a PIN-based transaction. The payment terminal may be configured to query the customer for an amount of cash-back, and may be configured to omit querying the customer for an amount of cash-back in response to the sales device having insufficient funds.

The payment terminal may be configured to transmit cash-back information to the sales device to at least one of (1) provide a prompt to provide cash-back to the customer, (2) verify that an amount of the cash-back is correctly entered by the cashier, and (3) provide a prompt to in response to an error in entry of the cash-back. The payment terminal may be configured to enable splitting the transaction into a plurality of payments using at least one of (1) cash, (2) a card, (3) a coupon, (4) a gift card, (5) and a check, thereby enabling separate recording of each payment on a receipt. The payment terminal may be configured to display a tab and prompt to enter a gratuity amount by selecting from at least one of (1) a choice of percentages, (2) leaving no gratuity, and (3) entering a gratuity amount. The payment terminal may be configured to generate a receipt including the tab, tax, and gratuity, thereby speeding service and eliminating a need for separate authorization without the gratuity and subsequent manual entry of the gratuity. The payment terminal may be configured to provide a prompt to enter the gratuity amount on the sales device, and may be configured to provide a prompt to query whether a receipt is to be printed based on an amount of the transaction. The payment terminal may be configured to provide a receipt comprising the tab and an area to insert at least one of a (1) gratuity percentage, (2) gratuity amount, (3) no gratuity, and (4) signature. The payment terminal may be battery-operated, wireless, and configured to be brought to the customer to complete the transaction and print a receipt showing the gratuity amount.

The payment terminal may be configured to provide a prompt to enter an amount of the gratuity on the sales device, and provide a prompt indicating that the gratuity amount entered into the sales device is incorrect. The payment terminal may be configured to provide prompts to a plurality of customers to share in payment of the transaction, and provide separate receipts to each of the plurality of customers. The payment terminal may be configured to suppress printing of receipts associated with transactions not requiring a signature, and notify the customer of the suppression of printed receipts. The payment terminal may be configured to authorize payment using a gift card based on available balance sufficiency associated with the gift card, and to provide an available balance associated with a gift card in response to the available balance being less than a threshold. The authorization request information may include identification information associated with the payment terminal to enable verification that the payment terminal is correctly associated with a merchant. The payment terminal may be configured to transmit cumulative transaction information to enable matching the cumulative transaction information with electronic payments received by the payment authorization system, thereby enabling a plurality of transactions to be balanced.

Any combination of the above features is envisioned. Other objects and features will become apparent from the following detailed description considered in conjunction with the accompanying drawings, wherein like reference numerals in the various drawings are utilized to designate like components. It is to be understood, however, that the drawings are designed as an illustration only and not as a definition of the limits of the invention.

Objects and features of these embodiments will become apparent from the following detailed description considered in conjunction with the accompanying drawings. It is to be understood, however, that the drawings are designed as an illustration only and not as a definition of the limits of these embodiments.

### BRIEF DESCRIPTION OF THE DRAWINGS

The accompanying drawing, which is incorporated in and constitutes a part of this specification, exemplifies the invention and together with the description, serves to explain the principles of the invention:

FIG. 1 shows a secure payment terminal (SPT) attached to an electronic cash register in accordance with an embodiment.

FIG. 2 shows an SPT (secure payment terminal) in accordance with an embodiment, which communicates directly with an SPS (secure payment switch) that connects to a payment processor.

FIG. 3 is a flowchart showing an embodiment providing a method associated with a retail mode, in which a cashier rings a sale into a cash register (SRD) and bags it while a customer swipes the card on a secure payment terminal (SPT) and selects a type of card or payment.

FIGS. 4A-b is a flowchart showing an embodiment providing a method associated with a foodservice mode, in which a cashier enters an amount of a table check into an SRD that is monitored by an SPT that prompts the customer for a tip or gratuity.

FIG. 5 is a flowchart showing an embodiment providing a method associated with a PC-POS or kiosk mode, in which an SPT accepts an authorization request from the PC-POS/kiosk and obtains an authorization.

FIG. 6 is a block diagram of an embodiment of a machine in the form of a computing system, within which is a set of instructions, that when executed, cause the machine to perform any one or more of the methodologies disclosed herein.

### DETAILED DESCRIPTION

The following terminology is used herein.

| | |
|---|---|
| Cash Register | A device used by retailers and other entities that collect payments for |
| | merchandise and services in a face-to-face serially numbered transaction |
| | from consumers. It generally displays the amount of the transaction to the |
| | customer and/or manager/owner of the selling facility to audit for accuracy, |
| | and provides a printed receipt for consumers, and a transaction journal, and |
| | accumulates totals of transactions for balancing purposes. |
| ECR | An electronic cash register operates from a program stored in non-volatile |
| | memory, and accumulates totals of sales in the register that may be |
| | summarized in the store by a master register or external device that extracts |
| | the totals via a simplified in-store network. |
| POS | An electronic cash register that operates from a program stored in volatile |
| | memory captures detailed data and communicates it to a head office for |
| | audit and sales analysis. |
| SRD | A sales recording device or sales device that may be a POS, ECR, or PC. |
| COUNTERTOP | An electronic terminal that stands beside, that is not connected or |
| or | integrated with a cash register, but is used to read account numbers and |
| STANDBESIDE | other data from magnetic stripe cards swiped by a cashier. The transaction |
| | amount and type are manually entered. |
| SCAT ® or SPT | A smart customer activated terminal or secure payment terminal or |
| | payment terminal that can read details of a sale from a SRD and account |
| | numbers and other data from magnetic stripe cards swiped by a customer, |
| | and that may also be read from other mediums such as RFID/NFC. The |
| | SCAT ® determines the type of account from its internal database of |
| | customer responses about cards previously read, e.g., debit, ATM, EBT, or |
| | credit. When appropriate, the SPT prompts for entry of a PIN and encrypts |
| | it. It communicates directly to a SPS (secure processing switch), and |
| | communicates directly to an acquirer/payment processor for authorization. |
| PIN PAD | A special-purpose terminal connected to a countertop, POS, or PC to allow |
| | secure entry of a PIN (personal identification number). |
| SPN | A secure payment network that passes card transaction data between stores |
| | and acquirers, processors, card associations, and/or card issuers. |
| SPS | A secure payment server, payment authorization system, or gateway that is |
| | remote from the store and accepts messages via dial-up telephone |
| | (including cell phone) or Internet communications from an SPT and |
| | forwards them to a secure processing center. |
| STM | A secure terminal manager used to communicate directly with a SCAT ® |
| | via dial-up lines to upload programs, changes and files, or extract |
| | transaction logs. |
| SPC | A secure processing center (or processor) that approves/denies |
| | transactions. |

MLS (multi-lane-system) systems of checkout were first adopted by supermarkets, which were followed by mass merchandise stores that also use front-end checkout. The mass merchants typically average about 9-10 items per transaction, which is about half what supermarkets experience, so the electronic payment process is a much larger share of the total checkout time, and a customer activated terminal, the CAT which faces the customer and invites them to swipe a card, working under control of a POS register, speeds checkout even more than for supermarkets. The CAT, as a result, is now used in all non-food chain retailers including department stores, specialty chains, home improvement stores, specialty mass merchandisers, and QSR (quick service restaurants) because the CAT speeds service. Especially in front-end checkout, in which careful placement of the CAT also invites the customer to move to the end of the lane and begin the electronic payment process.

The CAT also facilitates use of so-called “contactless cards” that are tapped instead of swiped as required for conventional magnetic stripe cards. However, while contactless cards are easier to use and slightly faster than swiping, but when used with a customer-facing, CAT in a merchandise store, there is little actual difference in checkout time because in most cases the merchandise entry is so much longer than swiping. If the CAT does not have fast on-line communications, there would be no benefit. Therefore, contactless cards have thus far had little acceptance in merchandise retailing, and virtually none in smaller merchants because they do not have either CAT or fast communications. The embodiments disclosed herein fulfill both of these requirements while facilitating acceptance of contactless technology in a new application that will undergo extensive testing in 2011, mobile/NFC (near-field- communications) where the contactless NFC technology is embedded in a cell phone so the customer does not need a card. The effect of the CAT and mobile/NFC on smaller retailer's checkout time will be much greater that for larger retailers because the smaller retailers only average 1-2 items per transaction, and thus the payment process is a much larger proportion of the total checkout time.

The MLS system using a CAT described above sends the card swipe information and PIN (when used) to the authorization processor via a modified POS register and then via an in-store (POS) controller, and through the retailer's own communications network through a central consolidator using a high-speed dedicated communication path to a processor. The authorization response is then returned via the same path to the POS for printing of receipts and/or drafts by the POS. An ECR cannot be used at all for this system.

In contrast, the embodiments disclosed herein are directed to a unique method of integration that does not use the POS or it's network at all, does not require any change to a POS or ECR and keeps sensitive data out of the POS and the POS communications infrastructure, in which the majority of in-store breaches (theft of cardholder data) are believed to occur.

Non-food store POS systems typically generate a transaction log that lists transactions in detail for those stores or chains that have sales-driven replenishment, such as department stores, chain specialty stores, and discount department stores. The embodiments disclosed herein provide as an option, the same type of detailed transaction log (without the secure cardholder information), which provides smaller retailers with the same data that larger chains use for sales analysis and replenishment.

The question “debit or credit?” which must be asked by the cashier to determine whether a card is to be used with PIN, or without (even with the early MLS), has been a point of confusion and has slowed the checkout process. It is not the correct question; it should be: (a) “is this a credit card or a debit card that you want to process like a credit card (with signature)”; or (b) “is it a debit card you would like to use with PIN”? Since the fee structure for PIN debit has a cap on the amount charged for a transaction, debit cards used with PIN over a certain dollar threshold cost the retailer a lower fee than when used with signature (which is technically referred to as “off-line debit”). This threshold varies by type of card and retailer's contract rates, but savings increase exponentially as the transaction value increases above the threshold amount.

Since fees paid by retailers to accept debit cards are lower when PIN is used, larger retailers with sophisticated MLS have begun to adopt a procedure called “steering” or “prompting”, in which the POS system accesses a remote database of BIN (bank identification numbers) via the POS communication infrastructure to determine whether a card is a debit or credit. If it is debit, the customer is asked to enter their PIN. Retailers are required to allow the customer to opt out and use their signature, which is usually done to take advantage of reward programs or perceived float.

Smaller stores have not been able to implement CAT because it has not been possible to interface such a terminal to an ECR or POS, and the MLS system to support it is too expensive. Therefore, neither a CAT, nor debit steering or prompting possible, which places smaller retailers at a serious cost disadvantage and with a much slower checkout. The embodiments disclosed herein provide such a system in a unique way that also significantly reduces interchange rates.

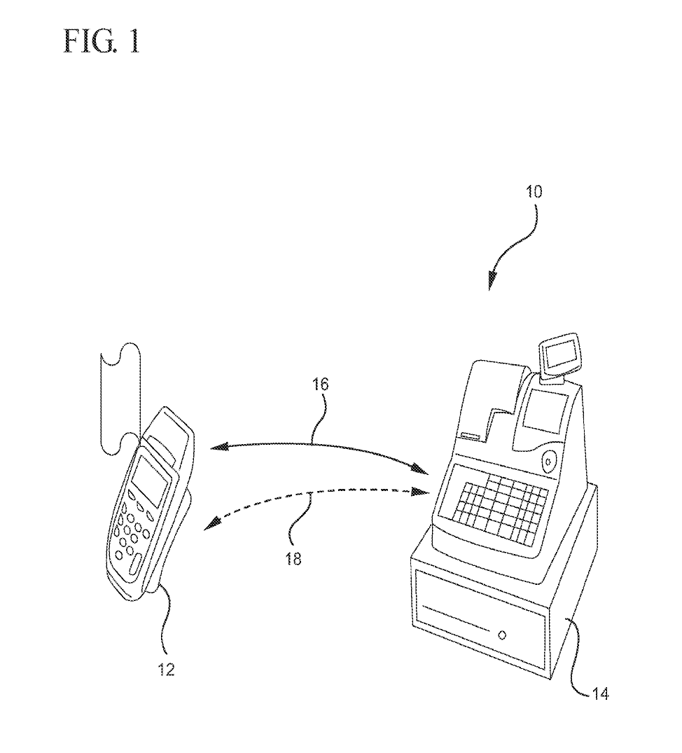

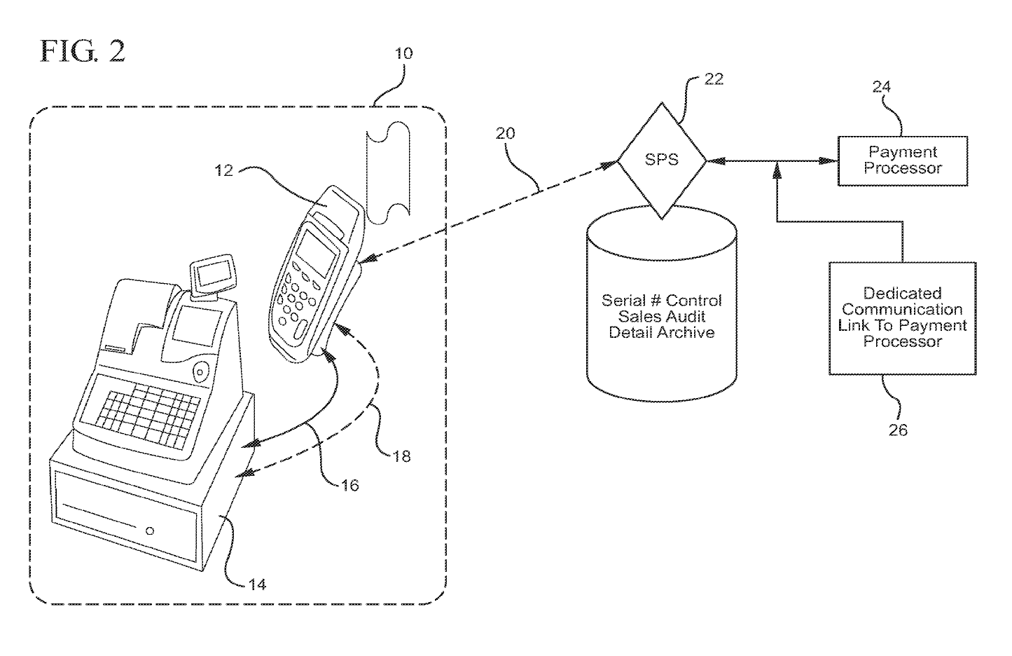

An embodiment is directed to a system 10 to simplify the integration of electronic and other non-cash payments into the sales checkout process of smaller retailers and to speed customer service while reducing the fees and other costs of non-cash payment acceptance. As shown in FIGS. 1 and 2, it does this by attaching a special CAT (customer activated terminal) 12 to an electronic cash register 14 in smaller retailers, wherein the CAT will monitor the operation of the electronic cash register 14 without changing the ECR and/or POS or sending any confidential information to the ECR and/or POS. Whether an ECR, POS, or PC 14 on a drawer is used, the cash register is referred to hereinafter as an SRD (sales recording device) 14. The disclosed embodiments bring particular benefits to small retailers that have had to use slow and inefficient methods for acceptance of cards to pay for merchandise and services using a non-attached payment terminal (standbeside or countertop) that requires a cashier to first ring a sale on the SRD 14, and then key enter the total amount and other information concerning the transaction to be authorized into a standbeside. The entire transaction can take twice as long as the same transaction in larger retailers, but does have the advantage of less exposure to theft of cardholder data if the standbeside uses a dial-up communication link smaller retailers have been forced to use this error-prone, non-attached payment system since the early 1980's putting them at a cost and service disadvantage to larger stores and chains of smaller stores. The larger retailers rejected the use of standbeside terminals and refused to accept the general purpose credit cards of that period until the card swipe could be integrated into their POS cash registers by adding a magnetic stripe reader and modifying the cash register logic to accept the account number when a card was swiped. The cashier entered the description and items being sold, colloquially referred to as ringing a sale, and then asked the customer to hand their card over to the cashier to swipe. The cash register then communicated the transactions to be authorized via the retailer's own communication network to a central computer that was in turn connected to a payment processor and then to the card issuers via associations including Visa, MasterCard®, Discover®, American Express®, and the like. When an approval was returned via the same pathway, the sale was completed by the cash register and the store's regular receipt or sales check would be printed.

The cost and speed advantage that larger retailers have had over smaller retailers has further widened with the evolution of processes for accepting debit cards, wherein large merchants can avail themselves of the savings available when the customer enters a PIN after swiping their card. Larger retailers found they could speed the process even more by attaching a CAT controlled by the SRD that can ask the customer to swipe a card on command from the SRD. When the customer swipes their card, their card holder account number is sent to the SRD, which accesses an external database via the retailer's own communication system, and then via the Internet, to identify whether a card is a debit or credit, and if it is a debit, to send an instruction to the SRD and then to the SPT that will automatically prompt the customer to enter their PIN.

FIG. 1 shows a payment terminal device system 10 in accordance with an embodiment, which is accessible to and usable by a customer to enter private information that may then be secured by encryption. Unsecure information may be printed on a receipt and draft by the SPT 12 directly on its own printer, or by communication to a remote printer, including one on the SRD 14.

FIG. 2 shows the SPT 12 in accordance with an embodiment, which communicates directly with an SPS (secure payment switch) 22. The SPS 22 may hold the line open while the SRD 14 and SPT 12 complete the transaction, and send an authorization request, in which the SPS 22 may verify the hardware serial number of the SPT 12, then receive details of the transaction and pass these details to the appropriate processor.

A method in accordance with one embodiment, which is shown in FIG. 2, includes attaching an external device, such as a customer activated SPT (secure payment terminal) 12 via either a wired 16 or wireless 18 communication link to an SRD (sales recording device) 14, such as a cash register, in a non-invasive manner such that the SPT 12 can monitor operation of the SRD 14 by reading transaction information or an electronic form of what would be printed by the ECR 14 and/or POS from an existing interface of the sales device without modification of the sales device, or any alternative electronically readable output of the ECR and/or POS via a first interface of the SPT. Thus, the SPT 12 knows when the cashier begins ringing a sale on the SRD 14 and without knowing whether the payment will be by cash, check, store credit, or a general purpose credit (e.g., Visa®, MasterCard®, Discover®, American Express®, and the like) it initiates via a second interface of the SPT: (1) a dial-up connection 20 over a standard telephone line (POTS) to a remote SPS (secure payment switch) 22 to authorize a transaction by sending authorization request information, and (2) a prompt to the customer to swipe their card, despite the sale not having been completed by the SRD 14. The SPT 12 can determine the sale amount when the SRD 14 has completed recording the details of the transaction from the electronic output of the SRD 14, and if a card has been swiped and the cashier depresses an appropriate key on the register, the SPT 12 proceeds to send authorization request information directly to the payment processor 24 via a dedicated communication link 26 while the SRD 14 remains in a wait state, awaiting an acknowledgment from the SPT 12. This unique approach also serves to keep the customer account information or payment information completely out of the SRD 14 while it communicates the payment information detail directly to, independently of, and without modification of or changing the hardware or software of the SRD 14 or involving the SRD 14. This method results in the lowest cost and the greatest security since it keeps the cardholder account information data out of the SRD 14 and in a secure device that is not normally connected to the Internet.

The SPT 12, while transaction details are being entered into the SRD 14 by a cashier and the SPT 12 is initiating communications directly with the remote SPS (secure payment server or payment authorization system) 22, the SPT 12 also conducts a dialogue with the customer to obtain their payment information (such as their card number and PIN) and their instructions concerning payment type.

When the transaction entry to the SRD 14 is completed, the SPT 12 can then send an authorization request to a secure payment switch 22 for further transmission to a payment processor 24, or directly to a payment processor 24. The SPT 12 may also takes advantage of changes in electronic payments rules and fees to reduce the total cost of card acceptance, including so-called interchange fees and surcharges. The advantageous feature of pre-dialing mitigates the cost and speed advantages gained by larger retailers through a progression of modifications to their open architecture SRDs, such as use of a CAT to obtain the customer information and the SRD's high speed supporting communication infrastructure to send an authorization request to a payment processor. The disclosed embodiment allows the SPT 12 to capture a PIN with a debit card and include it in the authorization request sent directly from the SPT 12 to a remote processing switch ##, or even transmit it directly from the SPT 12 to the SPS 22 or to a payment processor 24. These steps, when conducted by an open architecture SRD through its own communication infrastructure are potentially insecure and open to external access by unauthorized computers that can compromise the customer's account numbers and other identifying information. Due to the secure method of attachment to the SPT 12 of the disclosed embodiment, the latest changes in electronic payments rules can advantageously be applied directly to the transaction because the SPT can easily be kept up to date directly via a secure terminal management system since it is not dependent on a host SRD. These changes are occurring at an increasing rate to accommodate the changing types and mixes of payment types and account number entry methods, as well as the unique characteristics of new devices, such as mobile phones that enable new ways for customers to carry and enter their personal and private account numbers into payment systems to purchase goods and services.

The SPT 12 monitors the operation, entries, and actions of the SRD, particularly of ECRs (electronic cash registers) which is the predominant type of SRD used in small retailers that may have limited or no communication capability. The ECR generally has a program and proprietary operating system stored in ROM (read only memory) and uses a specialized computer chip, rather than a general-purpose (open architecture) CPU, that is less costly, more reliable, more secure, and more difficult to access since it is custom programmed without using widely available tools or open architecture with open two-way communication channels of the POS registers used by larger stores and chain retailers. The program and operating system of the POS is in rewritable memory and controlled by general-purpose and less secure operating systems, such as Windows®, UNIX®, and Linux® co-resident in the same rewritable memory.

The disclosed embodiments enable the SPT 12 to monitor the operation of the SRD 14 and perform the authorization process by withholding response to, and without changing the program of the SRD 14 that is embedded in the ROM of the SRD 14. The SPT 12 may then complete the electronic payment process while leaving the SRD 14 in a wait state. Only the SPT 12 can control the payment process because it has conducted a private and secure dialogue with the customer and directly with a remote processing facility via secure dial-up communications. The SPT 12 is able to conduct the finalization of a payment approval (or disapproval) directly between the customer and the SPS 22 without requiring attention from the cashier, unless the customer has a special requirement such as desiring cash-back when using a debit card. The SPT 12 can, when necessary, send non-secure information to the SRD 14, prompting the cashier to enter non-confidential information, such as the amount of cash-back to control the process. The SPT 12 can then audit the output of the SRD 14 to be sure that the cashier has done what was intended—all without changing the SRD 14 program and its inherent security.

An example of the SPT's (12) advanced control of the SRD (14) is cash-back with a debit card payment. A customer enters the amount of cash-back that they desire into the SPT 12 and the SPT 12 can send a message to the existing cashier display of the SRD 14 via an input/output port of the SRD 14 used by various peripherals. The message in clear text instructs the cashier to enter the cash-back amount so that both the SRD 14 and the SPT 12 will have the same CashBack Amount. The SPT 12 then examines the CashBack Amount entered to verify its correctness. Then the SPT 12 can conduct the secure payment transaction including cash-back with the SPS 22.

The SRD 14 operation is monitored by the SPT 12 by reading any data output by the SRD 14 via general or specialized I/O ports of the SRD 14, such as those that send printing information to an external slip printer, or kitchen printer used by the SRD 14, or those that communicate with external devices, such as a scanner, change dispensing device, weight scale, modem, external display, or other peripheral. That information has no particular value and cannot be accessed by hacking because the SRD 14 is not connected to external communications networks). The ECR type SRDs used in most small retailers do not have the same open access ports that the PC-based POS terminals have, and with the disclosed embodiments, there is no useful information in the SRD 14 anyway because it is essentially isolated from the payment information in the SPT 12. While monitoring the SRD 14, the SPT 12 simultaneously interacts with a customer desiring to pay for merchandise or services, who will enter their private payment information, such as an account number and expiration date into the SPT 12. The SPT 12 will manage the process using input from the customer and selected non-private information retained from prior customers using the SPT 12 or other SPT's in the same store, and with the latest rules uploaded in the SPT from a complementary remote TMS (secure terminal management server). The SPT 12 will at the same time directly establish a connection to the SPS 22 such that when the transaction is complete, the SPT 22 may forward it to a processor for approval and/or acceptance of the transaction. If approved, the SPT 12 will then complete the transaction, including the printing of a merchant draft, customer receipt, and other documentation, or tell the SRD 14 to do so by sending the necessary non-secure printer data, such as card type, the low-order 4 digits of the account number, reference number, approval code, and special instructions or information such as “no signature required”, cash-back, and the like in clear text to the SRD 14. Any security-sensitive information contained in the customer's card, fob or other medium is never sent to the SRD 14, and is only retained in the SPT 12 until the successful completion of the transaction. The SPT 12 retains only a cross-reference to the secure sensitive information held by the SPS 22, and even that may be encrypted. Any information printed by the SRD 14 does not contain security-sensitive information, is never printed or sent to the SRD 14 by the SPT 12, and is cleared from the SPT 12 as soon as the transaction is approved and printed or print data is sent to the SRD 14 or external printer and acknowledged.

The SPT 12 combines the actions of, and information entered into the SRD 14 with information that the SPT 12 obtains from customer answers to questions posed by the SPT 12 to the customer who may respond via key depression, tapping, or passing through the NFC (near-field radio field), swiping or insertion of a separate data storage medium and/or customer specific identification mediums, such as magnetic stripe cards, biometric readers, contactless cards or stickers, RFID and bar codes. The customer identification medium may be inserted into, or it's information transmitted or read from a customer-carried device such as a card, fob, or cell phone.

The interaction of the SPT 12 with the SRD 14, the customer, customer information medium and, when necessary, an external database enables a secure, efficient, and coordinated payment process, that is independent of the SRD 14. Upon completion and approval of the transaction, the SPT 12 may print a customer receipt and merchant draft for signature or accounting directly through its own printer or through the SRD's printer by sending the information to the SRD 14, or a designated remote printer. It may also record or print a store journal of activities (omitting or truncating any private customer information, such as account number that could be used to conduct fraudulent transactions). The SPT 12 may print through a remote printer attached to it via a wired, wireless, light, or optical connection. Information printed may or may not include the customer name, but will include such cross-reference information as a date, time, store number, transaction number, truncated account number (showing only the low-order 4 or 5 digits), approval number, reference number, and any cross-reference such as batch identification from an external computer, database, or encrypted information representation.

The SPT 12 payment procedure, except for the translation of individual SRD 14 input, is the same for most SRDs, and control of the process by the SPT 12 further simplifies sale, installation, and support through a single existing channel of distribution instead of a plethora of overlapping, expensive, and competing channels.

A further embodiment of the invention is directed to an SPT that identifies the type of account. Thus, a debit card is identified as a debit card by the SPT and further identified as to whether it is accepted with PIN only, or may be used with signature. If the signature is to be captured by writing on the draft or the screen of the SPT, the SPT instructs the customer and cashier what to do.

An embodiment of this invention is directed to a SPT (secure payment terminal apparatus) in which the apparatus is a SCAT® (smart customer activated terminal) that assists the merchant in reducing transaction fees by automatically identifying the type of card proffered by a customer by matching a designated portion of the account number (BIN (bank identification number) to a list of BIN numbers previously read by the CAT and stored in the CAT after the customer identified the BIN number as debit and which was approved as a debit. It also identifies which of those cards are usable only with PIN (such as ATM cards) and which may be used either way. If a card is identified as a debit by the customer or the reference to a BIN file in the SCAT®, the SCAT® automatically prompts the customer to enter their PIN. If the transaction value is below a threshold stored in the SPT for the particular retailer, the PIN is omitted from the authorization request, unless the card is an ATM-only card that can only be accepted with a PIN. If a gift card is proffered, the SPT may determine the balance (if available) before attempting to complete the transaction by accessing a remote database of balances.

A further embodiment of the invention is directed to an SPT that identifies the type of account. Thus, a debit card is identified as a debit card by the SPT and further identified as to whether it is accepted with PIN only, or may be used with signature. If the signature is to be captured by writing on the draft or the screen of the SPT, the SPT instructs the customer and cashier what to do.

The SPT may, for a prepaid card, which may be a gift card, show the remaining balance available after the payment is deducted, and a loyalty card may show information relative to the customer's bank of points. A draft agreement to be signed by the customer would be produced with a signature line when signature is required to be written on the draft, but not if a signature is not required due to the low value of a transaction. A drawer copy of the payment may be printed or not, depending on a retailer's system requirements and whether or not a signature was electronically captured. The SPT may also report the total number of documents that should be in the drawer to simplify end-of-day reconciliation.

An embodiment of the invention provides a customer actuated terminal or SPT attached to an SRD so that the SPT can monitor the operation of the cash register by receiving or intercepting, in digital form, all or part of the receipt or journal print line, which is an image of what would normally be printed by the SRD. As soon as the SPT recognizes the beginning of a transaction by the SRD, it starts the communication process to connect to an SPS (secure processing switch) that will establish the connection and hold the line open until the SPT ascertains that there will not be an authorization required or sends an authorization request.

A further embodiment of the invention includes an SPT that can serve as a customer display, which is legally required in some states, showing the detail of each transaction as rung. The SPT may be picked up and held by the customer for convenience and/or secure entry (and may be in a cradle that allows it to be picked up but protects it from being dropped) and may have a shield to obscure key entry of the PIN from all but the customer.

A further embodiment of the invention is directed to an SPT (secure payment terminal) that may determine from the details of the transaction that the transaction does not require remote authorization because it is to be settled with cash or any other medium of payment not requiring authorization. The SPT will then hang up, or discontinue the communication session if the transaction is fully paid for by cash or other medium not requiring authorization.

A further embodiment of the invention is directed to a method of performing financial transactions between a customer and a merchant, which includes the steps of inputting two or more payments by the customer into the SPT in connection with a single purchase transaction, and transmitting the payment information for each payment individually to an SPS, and continuing to authorize payments until the payment has been completed.

A further embodiment of the invention is directed to a secure payment terminal that may re-transmit the details of the transaction immediately as received if, for example, required for a digital video recording system.

A further embodiment of the invention is directed to a secure payment terminal that may also send the detailed line items of previous transactions to a complementary server over the open communication circuit, trickling them while awaiting response from a remote authorization system, either during the same or subsequent transactions—with this communication being trickled only until a communication session is concluded by either the SCAT® or the remote server, and then resumed during subsequent communication sessions. Alternatively, the SCAT® may call a designated local computer that may be in the store or remote, and send the transaction log for audit and analysis.

A further embodiment of the invention is directed to an SPT that retains the non-secure details of each transaction and communications to and/or from external systems in a transaction log for several days for audit and analysis, but does not allow changes to the detail once logged.

An embodiment of the invention provides a payment system between a customer and a merchant comprising a SRD and an SPT, wherein the SPT monitors the details of the transaction in the SRD and customer entry from keyboard, screen touch, or a payment medium, such as a magnetic card read by swipe, touch, or other reading means. The detail accumulated may include actions, such as validation of the total, encrypted entry of PIN if appropriate, and details of the direct communication from the device to and/or from a remote transaction authorization system.

A further embodiment of the invention is directed to an SPT that receives complete detail of each line of a transaction as it is entered, or, in the absence of the complete detail of every line from the SRD, the SPT will receive pseudo requests for authorization that include codes to indicate an instruction or request from the SPT to change the operation and conduct a special procedure, such as void, or reset of the SPT, or provide a message to the SPT for display to the cashier and/or the customer. This also allows directions from the cashier to the SPT when necessary, allows audit of entries on the SRD by the SPT, and changes the process, such as by eliminating a step to accommodate faster checkout in peak periods.

A further embodiment of the invention is directed to a customer-accessible SPT that may invite a customer to begin the electronic payment process by finding their card and swiping, placing it into or waving/tapping it for a wireless read by the SPT. This may be enabled after the cashier begins ringing the sale on the SRD or after a delay set by the user retailer.

A further embodiment of the invention is directed to a transaction requiring customer entry before swiping or reading an account number, such as a request to enter a tip or gratuity, or add merchandise to an already complete transaction or table tab. The SPT may ask the customer to select a tip percent, or key in a tip amount if they wish to include a tip in the payment tendered to the SRD and SPT, or the customer may simply depress a cancel key and the SPT will return the SRD to sales entry mode.

A further embodiment of the invention is directed to a transaction in a food service retailer, in which the customer is presented with an enhanced table check showing the meal amount with or without tax at the user's option, and two or more suggested tip amounts and percentages with a space to write in the tip so it can be entered by the cashier or server when finalizing the transaction and receipt for the customer. The table check may also include the transaction number and provide a line for the customer to sign even though no card has been swiped, with appropriate terminology agreeing to pay according to the card issuer rules if they use a card for payment. The tip choice and signature may be written on the table check before the transaction has been authorized, thus permitting the server or cashier to complete the transaction and receipt in one less step and trip to the table ,and providing the customer with a complete receipt including the tip as billed to their card.

A further embodiment of the invention is directed to a transaction in a food service retailer, I which the customer desires to pay at a cashier, and the cashier enters the table tab amount or reference number and the table tab amount is displayed to the customer by the SPT, which asks the customer to select the tip per cent or enter the tip amount. The SPT will then ask for a card to be swiped or the customer to select a cash transaction and the payment procedure completed normally on the SRD and/or SPT.

A further embodiment of the invention is directed to a transaction in a food service retailer, in which the customer desires to establish a tab for an amount that the customer expects to spend, and as the customer orders further items they are deducted from the tab balance until it is exhausted. When the customer is done, the SPT may recall the tab and refund the original amount, then authorize it for the final amount, either more, less, or the difference, and receive only a single receipt for the visit.

A further embodiment of the invention is directed to a transaction in a food service retailer that allows two or more customers to share in paying for a meal in equal or differing shares, each being allowed to pay in one or more tenders, such as a gift card and credit card, and each receiving a receipt for their multiple tenders and share of the meal, tax and tip as well as the total meal amount.

A further embodiment of the invention is directed to a transaction in a food service retailer, in which the SPT may operate wirelessly and be carried to the table to allow the customers to pay while still at the table or counter where they ate or drank without giving up their payment cards to a server for use at an SPT located somewhere else in the restaurant. The same process may be applied, wherein the receipts and drafts are all printed at the table and the customers may pay using cash, checks, non-cash media, swiped magnetic stripe cards, contactless cards, or strips attached to mobile devices, such as cell phones equipped with transmitting payment mediums (such as NFC), or smart cards (with EMV chips) inserted into the SPT.

An embodiment of the invention provides that the SPT completes the electronic acceptance, if required, or determines that the transaction was satisfactorily completed and settled by the SRD. The SPT initiates and provides the information for printing of a complete transaction receipt to the SRD, to a remote printer, or prints the receipt and drafts itself. The SPT may print on an attached printer, have an integrated printer, send messages with information to be included on receipts printed by the SRD, or send full information for the SRD to print on the SRD printer. The information to be printed may include details of the transaction received by the SPT from the POS or ECR and may also include information determined by the SPT from it's interaction with the customer, the payment medium(s) and SPS (secure payment system).

The tangible benefits of the disclosed embodiments include lower cost, ease of connection to an SRD, faster checkout, ability to prompt for and accept PIN with certain card types, complete or partial control of printing formats, and improved accuracy by automatic transfer of table check and reference information (including date, register number, and transaction number from the SRD to the SPT.

A further embodiment of the invention is directed to an SPT integrated with an SRD may be used as a standbeside SPT in the event the SRD fails or is unavailable.

The SPT may be a standard off-the-shelf terminal that can be replaced easily in the field if it fails, with software appropriate to an individual user downloaded for quick actuation under control of an STM that verifies the hardware serial number before sending the program to the SPT.

A further embodiment of the invention provides a spare terminal that may be kept in a retailer's place of business for use as an immediate spare in case of failure of the SPT and also used as a peak period standbeside since the peak periods occur more frequently in smaller retailers. The SPT is kept under control of the SPS since each transaction includes a hardware serial number that is verified by the SPS on every transaction, and must be tested daily or it will be automatically invalidated by the SPS.

An embodiment of the invention is directed to an electronic copy of the transaction detail that may be transmitted via either a wired or wireless connection from the SPT to either the retailer's backroom server or to remote server that can be accessed by the retailer.

An embodiment of the invention is directed to little or no change required to the SRD, except to change user programmable key names and turn off receipt printing if possible. The SRD may not require a receipt printer, but rather depend on the printout by the SPT or a printer attached to the SPT.

A further embodiment of the invention is directed to an SPT that initiates communications to an SPS (see PDC below) and communicates with the customer, the SPT may not respond to the SRD until sale itemization and cash (or cash-like) tendering is complete or an electronic tender is required, at which time the SPT takes control of the transaction leaving the SRD in a wait state. For a cash sale, the SPT (instead of the SRD) may print the cash payment receipt. If part of the payment is an electronic payment, the SPT does the tendering of electronic payments, authorization, if any, and the printing of any drafts for signature unless no signature is required. The SPT may then add the electronic tendering information to a TL (transaction log) in the SPT memory along with any non-printed information in the TL to provide a complete audit trail of the process.

A further embodiment of the invention is directed to an SPT that may send a signal to the SRD after the transaction printing has been completed to notify the cashier that the transaction is complete and release the SRD. Alternately, the SPT may notify the cashier (via an audio or visual display) that the payments are completed and prompt the cashier to depress a key or keys on the SRD to return it to register mode. If an entry to the SRD is required, the SPT may monitor an I/O port to determine that the entry actually occurred and was correct.

A further embodiment of the invention is directed to an SPT that may request another tender choice from the customer or void the sale and all electronic tenders previously made for the same transaction if the electronic authorization results in a denial without any receipt being printed. In this case, the SPT may prompt the cashier to void the sale in the SRD. The SRD may also void a sale after completion and the SPT will automatically take appropriate action to correct any electronic payments authorized in the course of the transaction because it has all the information needed, even without retaining the actual cardholder account number.

A further embodiment of the invention is directed to an SPT that will add the results of electronic tendering, totals by type of electronic tender, voids, cash-back and off-line authorizations to the TL to supplement the cash register control totals that may be a single total of all transactions included in the TL at the end of the day. The SPT may also provide detailed reporting to balance to the single SPD total including cash-back and other auditable entries in the TL.

A further embodiment of the invention is directed to an SPT in certain embodiments that may be capable of handling new types of customer account identification such as contactless, RFID, NFC, and EMV smart cards.

An embodiment of the invention uses a PDC (pre-dialing connection) for conventional dial telephone service. Pre-dialing refers to when the SPT determines from the SRD that a transaction has started, it automatically initiates a communication connection (after a variable delay pre-set by the user) to a complementary switch or gateway without knowing whether the transaction will require authorization or not. After the connection is established, the complementary gateway will hold the line open until an electronic tender is sent by the SPT or the SPT sends a message to hang up, or simply hangs up. The SPT will retain control over the communication link by sending periodic instructions to the receiving gateway to either keep the line open or hang up. If the tender is all-cash or cash-like, the SPT will discontinue communication, print the receipt when it is complete, and return the SRD to a register mode. Since dialing time is not billable and the average connection time is slightly longer than the average ring time of most small store transactions, unused connection time will be minimal but authorized transactions will be processed at near broadband time.

An embodiment sets a delay based on transaction activity or user input to delay pre-dialing for a set interval to minimize hold times and re-dialing.

In another embodiment, the SPT may also communicate via persistent high-speed connections, such as the Internet, with an ability to dial via a standard telephone line as a back up.

In another embodiment, a printer is integrated in or attached to the SPT that will print some or all receipts drafts and reports in place of the SRD printer, or the SPT may print to the SRD printer either via instructions to the SRD or print lines sent to the SRD printer via a printer wedge that intercepts print instructions. A printer may be attached to or integrated into the SPT housing, or attached via a wired or wireless connection to allow a back-counter SPT or printer location with a customer-accessible SPT on the front counter. This allows the SPT to further shorten the checkout process by rearranging the data to print any drafts for customer signature first so that the customer can receive and sign any draft while their receipt is being printed. The SPT may also enhance the readability of printing by changing font sizes, types and formats as required for a particular country (e.g. Canada).

In an embodiment, the SPT may modify the authorization request message based on the type of card and transaction value to change the type of transaction from PIN to signature if it is below a threshold at which the PIN debit fee is higher than the signature debit fee. A further variation of this embodiment may occur when the SPT may advise the customer and cashier either by display and/or printing on the receipt or draft that a signature is not required. This results in optimizing costs to the retailer and speeding checkout. The SPT may notify the customer how payment was treated, that is, as a signature debit or PIN debit, and note this in the transaction log.

In an embodiment, the SPT may, depending on parameters set by the retailer, self-authorize certain low-value transactions that may be permitted to be aggregated and submitted in a batch to obtain lower fees.

In an embodiment, the SPT may dynamically build a BIN (bank identification number) table of cards actually used at the SPT. The BIN table will identify cards as debit, ATM, credit, prepaid, EBT, or others to simplify operation or reduce costs. The SPT may provisionally accept a customer identification of card type (e.g., debit, ATM or credit) and then track the results of the authorization before confirming card type in a BIN table. The SPT may establish a provisional status for a particular BIN as a credit until a programmable number of customers have indicated the same. Similarly, some cards, such as debit and ATM cards, may immediately be identified as such in the BIN table based on being approved by the remote approval system or SPC. In an embodiment of the invention, the SPT may determine, from its own table or a remote host, the type of card and immediately ask the customer to enter the PIN with a particular card type, such as a debit card, but allow the customer to opt out and not enter PIN if they wish, unless the card is an ATM card that does not allow non-PIN transactions.

In an embodiment, if any BIN is not in the SPT BIN table, the SPT will conduct a customer dialogue to determine the type of card from that customer (such as debit or credit) and wait for the appropriate remote authorization systems to approve the transaction before placing the BIN in the table. Future uses of cards with the same BIN will automatically be detected and the time-consuming process of prompting the customer for a card type eliminated.

In an embodiment, the SPT may, based on it's own algorithm, or a message received from a complementary gateway or the SRD, identify special entries such as voids, cash-backs, tax exempt, and pay-outs to be included in the transaction log to assist in balancing the till or cash drawer and auditing for potential fraud or error operations. It may also access gift card balances and loyalty points or values for all customers who enter their loyalty number either through a swiped card or manual key entry (such as phone number) into the SPT.

In certain embodiments, a MICR (magnetic ink character recognition) check reader or check reader/scanner either with or without a printer, may be integrated or attached to the SPT via wired or wireless connections. The reader may read MICR encoding for check conversion and/or scan checks and/or signed drafts or other media such as credit/debit cards, driver licenses, signed drafts, or customer ID and pass the data and/or images to the SPT for archival and transmission to a complementary gateway.

In an embodiment, the SPT may communicate to a specialized (complementary) gateway that expects the same format of messages for all authorizations irrespective of the authorizing processor. Alternatively, the SPT may communicate directly to an acquiring processor's gateway after certification with that gateway.

In an embodiment, the SPT may trickle, that is, transmit during idle connection time while awaiting an authorization request response, the TL, including images of checks, signatures, drafts, and other printouts, to the complementary gateway, which may archive them for later retrieval via the Internet or other means available to the user. The complementary gateway may accumulate running totals of sales for the day from the TL by category or even item and consolidate the totals for all the ECR/POS/SPT of a store and/or chain. These features further reduce retailer's costs, improve efficiency, and provide access to information for more efficient operations.

In an embodiment, a complementary gateway may also trickle messages to and from the SPT including advertising text and images, and system parameters to the store during idle connection time awaiting response. Each of these messages may include delivery time, date, address, printer, SPT, and the like.

A complementary gateway may archive all transaction authorization requests with the responses, develop settlement batches, and allow reconciliation and/or balancing for the retailer via the Internet. The data may include the originating SRD's transaction or invoice number and other audit trails.

In an embodiment, a customer-facing SPT may be mounted on the register or counter. It may be held in a bracket, but may be removed from the bracket and handheld by the customer for security and/or ease of entry and/or use by handicapped customers. The bracket or the SPT may have a shield to obscure the entry of PIN from anyone except the customer. The SPT has a customer display and may have a secondary cashier/customer display either integrated in the housing or attached with either a wired or wireless connection.

In an embodiment, the SPT may store the last n keystrokes, except for those of the customer's PIN, to log them for support and error resolution.

In an embodiment, the SPT may operate as a standalone payment terminal in the event of SRD failure, thereby allowing the cashier to enter the transaction total and the customer to swipe or contact their payment medium, identify the type of card and authorize in the same manner as when it is connected to the SRD.

In an embodiment, the SRD may be operated as a standbeside if the SPT fails and the SRD has a printer.

In a further embodiment, the SRD may be operated as a standbeside, but accept split tenders and still produce only one receipt.

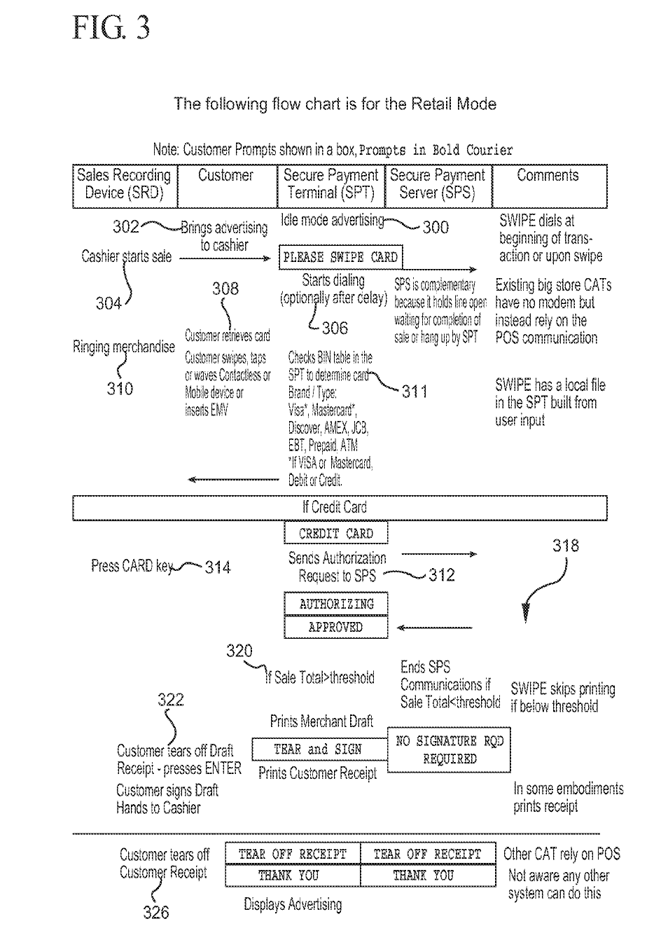

FIG. 3 is a flowchart showing an embodiment providing a method associated with a retail mode, in which a cashier rings a sale into a cash register (SRD) and bags it while a customer swipes the card on a secure payment terminal (SPT) and selects a type of card or the payment type and amount.

In step 300, idle mode advertising is displayed on the SPT, and the customer brings merchandise to the cashier in step 302. The cashier starts the sale on the SRD in step 304 and, if an electronic payment is selected, the SPT prompts the customer to swipe, manually key in, insert or pass through an NFC field to determine the customer's account number and other secure payment data for payment and starts dialing the SPS or optionally delays in step 306. The SPS is complementary if the SPS holds the line open waiting for completion of the sale or a hangup by the SPT. Larger store CATs have no modem and instead rely on the POS communication. If the electronic payment is a debit card, then the SPT will also prompt the customer for their debit PIN. The customer offers the payment card for payment and retrieves the payment card in step 308, and the cashier rings up the merchandise in step 310. The SPT checks the BIN table in the CAT to determine the type and/or brand of the payment card in step 311. If it is a credit card, the SPT sends an authorization request to the SPS in step 312 and, when finished with the sale or non-authorized tender, the customer presses the card key in step 314. The SPS receives the request and transmits an authorization response in step 318. The SPT ends the communication with the SPS and, if the sale total is greater than a threshold, the SPT prints the merchant draft and customer receipt in step 320. The customer signs the draft and takes the receipt in step 322. If the sale total is not greater than a threshold, the SPS prints the customer receipt, which the customer takes in step 326. The customer signs the draft and takes the receipt in step 322. Customer and cashier prompts are shown in bold in FIG. 3.

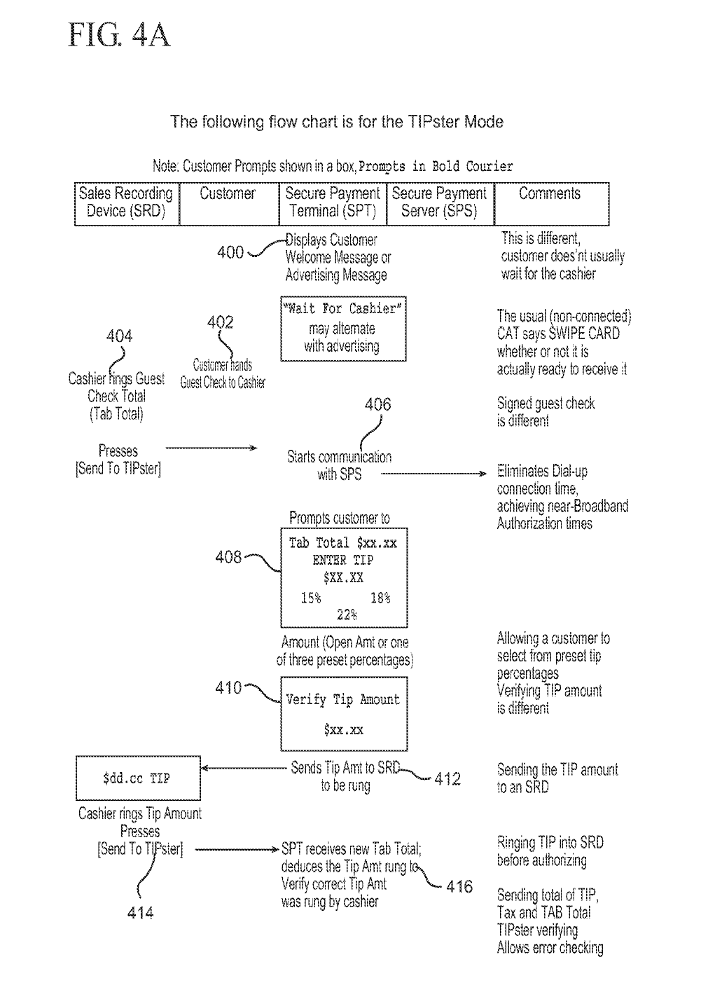

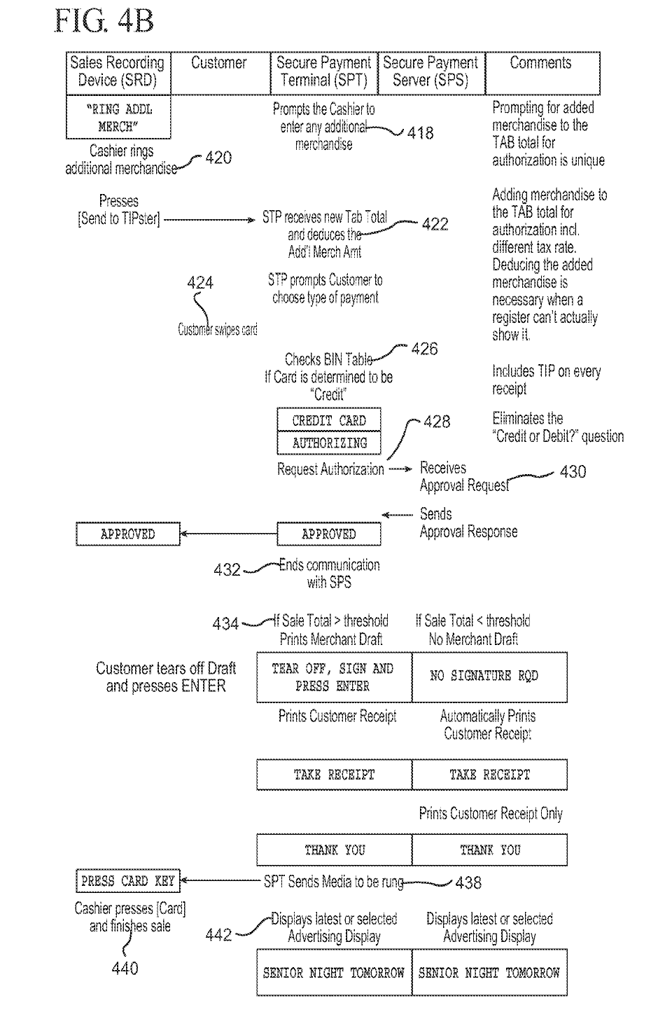

FIGS. 4A-B is a flowchart showing an embodiment providing a method associated with a foodservice mode or TIPster mode, in which a cashier enters an amount of a table check into an SRD which is monitored by an SPT that prompts the customer for a tip or gratuity. The purpose of the TIPster mode is to: (1) obtain a basic guest check total from the SRD; (2) prompt the customer to enter the tip amount; (3) optionally allow the cashier to enter additional merchandise on the SRD; (4) prompt the customer for the payment type and amount; (5) if an electronic payment is selected, then the SPT prompts the customer to swipe their card (or use any other payment method); (6) if the electronic payment is a debit card, then the SPT will also prompt the customer for their debit PIN; (6) obtain an authorization response for the transaction from the SPS; and (7) if the transaction is approved, print both the merchant draft and the customer receipt. These documents contain a full listing of all transaction amounts including the tip. Customer and cashier prompts are shown in bold in FIG. 4.

In step 400, the SPT displays a customer welcome or advertising message. In step 402, the customer hands a guest check to the cashier, and the cashier rings the guest check total on the SRD in step 404. In response thereto, the SPT initiates communication with the SPS in step 406, prompts the customer to enter the tip amount in step 408, and verifies the tip amount in step 410. In step 412, the SPT sends the tip amount to the SRD to be rung, and the cashier rings the tip amount in step 414. The SPT receives a new tab total and determines the tip amount rung in step 416, then verifies that the correct tip amount was rung by the cashier, and prompts the cashier to enter any additional merchandise in step 418. In step 420, the cashier may ring additional merchandise, and the SPT receives a new tab total and deduces the additional merchandise amount in step 422. The SPT then prompts the customer to choose the payment type.

The customer swipes the payment card in step 424, and the SPT checks the BIN table and determines whether the card is to be treated as a credit card in step 426. In step 428, the SPT requests authorization from the SPS, and receives an approval response from the SPS in step 430. In step 432, the SPT ends communication with the SPS, and if the sale total is greater than a threshold, prints the merchant draft and customer receipt in step 434. If the sale total is less than the threshold, the SPT only prints the customer receipt. In step 438, the SPT sends the type of media to be rung to the SRD, and the cashier presses the appropriate card type to complete the transaction in step 440. The SPT then displays an advertising message in step 442.

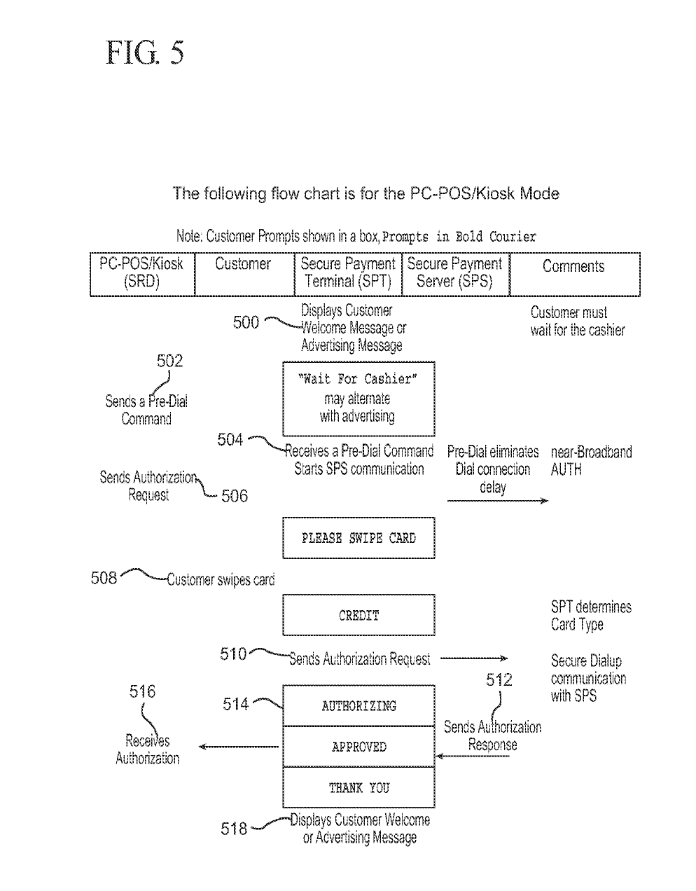

FIG. 5 is a flowchart showing an embodiment providing a method associated with a PC-POS or kiosk mode, in which an SPT accepts an authorization request from the PC-POS/kiosk and obtains an authorization. The purpose of PC-POS/Kiosk mode is to: (1) receive an authorization request from an external device or SRD, which operates as the supervising device; (2) obtain an authorization response for the transaction from the SPS; (3) send the authorization response back to the external device; and (4) if a fatal error occurs, then an error message is sent in place of the authorization response. This mode allows advanced systems, such as those in restaurants, to conveniently implement secure and PCI-compliant electronic payments.

PCI (Peripheral Component Interconnect) is an interconnection system between a microprocessor and attached devices, in which expansion slots are spaced closely for high speed operation. Using PCI, a computer can support both new PCI cards while continuing to support ISA (industry standard architecture) expansion cards, an older standard. PCI is designed to be synchronized with a clock speed of a microprocessor.

In step 500, the SPT displays a customer welcome or advertising message, and the SRD sends a pre-dial command in step 502. The SPT receives the pre-dial command in step 504, and starts communication with the SPS. The SRD sends an authorization request in step 506, and the customer swipes a payment card in step 508 in response to a prompt from the SPT. The SPT sends an authorization request to the SPS in step 510, and the SPS sends an authorization response in step 512. In step 514, the SPT sends an authorization response to the SRD, and the SRD receives and processes the authorization response in step 516. The SPT displays a welcome or advertising message in step 518.

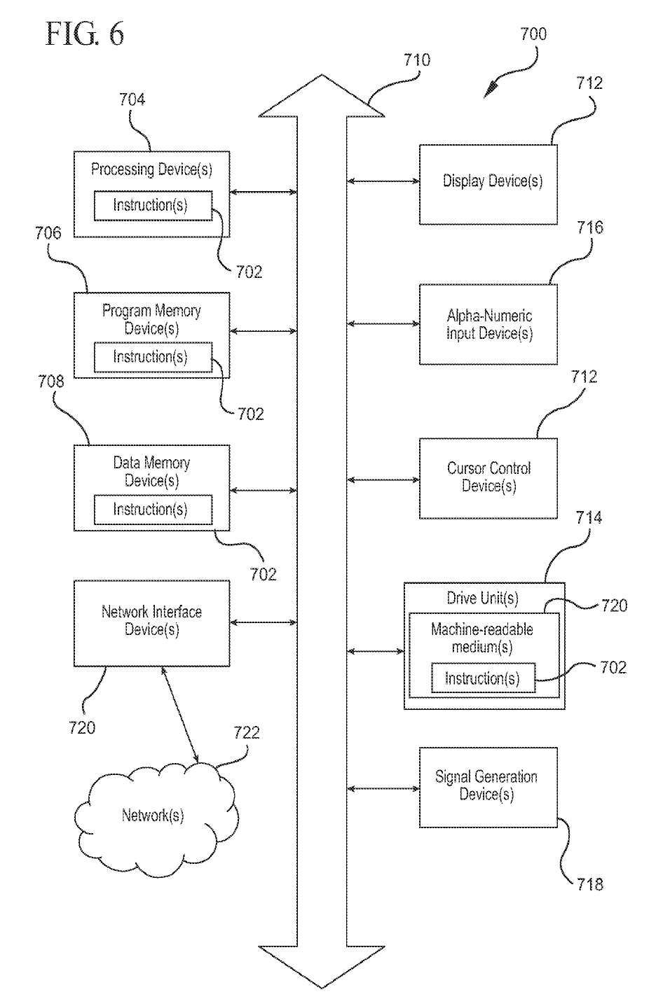

FIG. 6 is a block diagram of an embodiment of a machine in the form of a computing system 700, within which is a set of instructions 702, that when executed, may cause the machine to perform any one or more of the methodologies disclosed herein. In some embodiments, the machine operates as a standalone device. In some embodiments, the machine may be connected (e.g., using a network) to other machines. In a networked implementation, the machine may operate in the capacity of a server or a client user machine in a server-client user network environment. The machine may comprise a server computer, a client user computer, a personal computer (PC), a tablet PC, a PDA (personal digital assistant), a cellular telephone, a mobile device, a palmtop computer, a laptop computer, a desktop computer, a communication device, a personal trusted device, a web appliance, a network router, a switch or bridge, or any machine capable of executing a set of instructions (sequential or otherwise) that specify actions to be taken by that machine.

The computing system 700 may include a processing device(s) 704 (e.g., a CPU (central processing unit), a GPU (graphics processing unit), or both), program memory device(s) 706, and data memory device(s) 708, which communicate with each other via a bus 710. The computing system 700 may further include display device(s) 712 (e.g., liquid crystals display (LCD), a flat panel, a solid state display, or a cathode ray tube (CRT)). The computing system 700 may include input device(s) 716 (e.g., a keyboard), cursor control device(s) 712 (e.g., a mouse), disk drive unit(s) 714, signal generation device(s) 718 (e.g., a speaker or remote control), and network interface device(s) 720.

The disk drive unit(s) 714 may include machine-readable medium(s) 720, on which is stored one or more sets of instructions 702 (e.g., software) embodying any one or more of the methodologies or functions disclosed herein, including those methods illustrated herein. The instructions 87 may also reside, completely or at least partially, within the program memory device(s) 706, the data memory device(s) 708, and/or within the processing device(s) 704 during execution thereof by the computing system 700. The program memory device(s) 706 and the processing device(s) 88 may also constitute machine-readable media. Dedicated hardware implementations 704, but not limited to, application specific integrated circuits, programmable logic arrays, and other hardware devices can likewise be constructed to implement the methods described herein. Applications that may include the apparatus and systems of various embodiments broadly include a variety of electronic and computer systems. Some embodiments implement functions in two or more specific interconnected hardware modules or devices with related control and data signals communicated between and through the modules, or as portions of an application-specific integrated circuit. Thus, the example system is applicable to software, firmware, and hardware implementations.

In accordance with various embodiments of the present invention, the methods described herein are intended for operation as software programs running on a computer processor. Furthermore, software implementations can include, but are not limited to, distributed processing or component/object distributed processing, parallel processing, or virtual machine processing that can also be constructed to implement the methods described herein.

The disclosed embodiments contemplate a machine-readable medium containing instructions 702, or that receives and executes instructions 702 from a propagated signal so that a device connected to a network environment 722 can send or receive voice, video, or data, and to communicate over the network 722 using the instructions 702. The instructions 702 may further be transmitted or received over a network 722 via the network interface device(s) 720. The machine-readable medium may also contain a data structure for storing data useful in providing a functional relationship between the data and a machine or computer in an illustrative embodiment of the disclosed systems and methods.

While the machine-readable medium 720 is shown in an example embodiment to be a single medium, the term “machine-readable medium” should be taken to include a single medium or multiple media (e.g., a centralized or distributed database, and/or associated caches and servers) that store one or more sets of instructions. The term “machine-readable medium” shall also be taken to include any medium that is capable of storing, encoding, or carrying a set of instructions for execution by the machine and that cause the machine to perform anyone or more of the methodologies of the present invention. The term “machine-readable medium” shall accordingly be taken to include, but not be limited to: solid-state memories such as a memory card or other package that houses one or more read-only (non-volatile) memories, random access memories, or other re-writable (volatile) memories; magneto-optical or optical medium, such as a disk or tape; and/or a digital file attachment to e-mail or other self-contained information archive or set of archives that is considered a distribution medium equivalent to a tangible storage medium. Accordingly, the disclosed embodiments are considered to include any one or more of a tangible machine-readable medium or a tangible distribution medium, as listed herein and including art-recognized equivalents and successor media, in which the software implementations herein are stored.

Although the present specification describes components and functions implemented in the embodiments with reference to particular standards and protocols, the disclosed embodiments are not limited to such standards and protocols.

The illustrations of embodiments described herein are intended to provide a general understanding of the structure of various embodiments, and they are not intended to serve as a complete description of all elements and features of apparatus and systems that might make use of the structures described herein. Many other embodiments will be apparent to those of skill in the art upon reviewing the above description. Other embodiments may be utilized and derived therefrom, such that structural and logical substitutions and changes may be made without departing from the scope of this disclosure. Figures are also merely representational and may not be drawn to scale. Certain proportions thereof may be exaggerated, while others may be minimized. Accordingly, the specification and drawings are to be regarded in an illustrative rather than a restrictive sense.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to comply with 37 C.F.R. §1.72(b), which requires an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

In a particular non-limiting, example embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or instructions may be stored.

In accordance with various embodiments, the methods, functions or logic described herein may be implemented as one or more software programs running on a computer processor. Dedicated hardware implementations including, but not limited to, application specific integrated circuits, programmable logic arrays and other hardware devices can likewise be constructed to implement the methods described herein. Furthermore, alternative software implementations including, but not limited to, distributed processing or component/object distributed processing, parallel processing, or virtual machine processing can also be constructed to implement the methods, functions or logic described herein.

It should also be noted that software which implements the disclosed methods, functions or logic may optionally be stored on a tangible storage medium, such as: a magnetic medium, such as a disk or tape; a magneto-optical or optical medium, such as a disk; or a solid state medium, such as a memory card or other package that houses one or more read-only (non-volatile) memories, random access memories, or other re-writable (volatile) memories. A digital file attachment to e-mail or other self-contained information archive or set of archives is considered a distribution medium equivalent to a tangible storage medium. Accordingly, the disclosure is considered to include a tangible storage medium or distribution medium as listed herein, and other equivalents and successor media, in which the software implementations herein may be stored. Although specific example embodiments have been described, it will be evident that various modifications and changes may be made to these embodiments without departing from the broader scope of the inventive subject matter described (invention) herein. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

In the foregoing description of the embodiments, various features are grouped together in a single embodiment for the purpose of streamlining the disclosure. This method of disclosure is not to be interpreted as reflecting that the claimed embodiments have more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate example embodiment.

While exemplary embodiments have been described herein, it is expressly noted that the scope of these embodiments is not limited to these embodiments, but rather the intention is that additions and modifications to what is expressly described herein are also included within that scope. Moreover, it is to be understood that the features of the various embodiments described herein are not mutually exclusive and can exist in various combinations and permutations, even if such combinations or permutations are not made express herein, without departing from the spirit and scope of the embodiments.

1. A payment terminal comprising:
a first interface, the first interface being configured to receive transaction information from an existing interface associated with a sales device without modification to the sales device, the first interface being configured to transmit first authorization information to the existing interface associated with the sales device without requiring modification to the sales device, thereby enabling the payment terminal to monitor and authorize a transaction associated with the sales device; and
a second interface, the second interface being configured to transmit authorization request information associated with the transaction to a payment authorization system, the authorization request information representing the payment information associated with a customer, the second interface being configured to receive authorization response information associated with the transaction from the payment authorization system, the first authorization information being based on the authorization response information, the first authorization information not comprising the payment information.

2. The payment terminal defined by claim 1, wherein the existing interface associated with the sales device comprises at least one of a (1) printer port, (2) journal port, and (3) digital video port.

3. The payment terminal defined by claim 1, wherein at least one of the (1) first interface and (2) second interface is a wireless interface.

4. The payment terminal defined by claim 1, wherein the payment terminal initiates communication with the payment authorization system in response to at least one of (1) initiation of the transaction on the sales device, (2) termination of a delay following initiation of the transaction on the sales device, and (3) entry of an account number before or after the transaction has started.

5. The payment terminal defined by claim 1, wherein the payment terminal maintains a communication link with the payment authorization system until at least one of (1) the payment terminal receives the authorization response information, (2) the transaction is terminated, and (3) a timeout period with a reason code, the reason code being added to the transaction log and an alert being sent to a cashier, the payment terminal providing a method of entering a correction depending on the processor, thereby avoiding double-charging the customer.

6. The payment terminal defined by claim 1, wherein at least one of (1) the first interface and (2) the second interface comprises at least one of a (1) magnetic stripe card reader, (2) magnetic card scanner, (3) printer, and (4) printer port.

7. The payment terminal defined by claim 1, wherein the payment terminal is configured to activate a printer associated with the sales device or payment terminal.

8. The payment terminal defined by claim 1, further comprising a display configured to display the transaction information and information available from the sales device or payment terminal.

9. The payment terminal defined by claim 1, wherein the payment terminal is configured to record printed transaction information, non-printed actions, and register reports in a transaction log, the payment terminal being configured to transmit the transaction log in response to the second interface being idle or when scheduled at end of day.

10. The payment terminal defined by claim 1, wherein the payment terminal is configured to encrypt the payment information and identification information associated with the sales device and the payment terminal, the payment terminal being configured to transmit the encrypted information for authentication of the payment terminal.

11. The payment terminal defined by claim 1, wherein the authorization request information comprises secure information associated with the customer, the secure information comprising at least one of a PIN (personal identification number) if used, payment account, expiration date, and authorization information.

12. (canceled)

13. The payment terminal defined by claim 1, wherein the payment terminal uses a plurality of bank identification numbers to determine a type of card associated with the transaction as being one of credit, debit, EBT, (electronic benefit transfer) or loyalty, the plurality of bank identification numbers being associated with cards used in transactions on the payment terminal for which the type of card has been approved by a processor as debit, or as credit after a user set number of approvals, thereby eliminating a need to query customers to identify the type of card used in the transaction as being debit or credit while enabling the customer to opt-out of a PIN with debit transaction to a signature transaction if the card type is non-PIN-only.

14. The payment terminal defined by claim 1, wherein the payment terminal is configured to identify a debit payment transaction and prompt the customer to use PIN or a signature by comparing the payment amount associated with the transaction to a predetermined, user defined transaction amount threshold associated with a type of card.

15. The payment terminal defined by claim 1, wherein the payment terminal is configured to query the customer to enter a PIN (personal identification number) based on an amount of the transaction, the payment terminal enabling the customer to opt-out of a PIN-based transaction.

16. The payment terminal defined by claim 1, wherein the payment terminal is configured to query the customer for an amount of cash-back or omit querying the customer for an amount of cash-back in response to the sales device having insufficient funds.

17. (canceled)

18. The payment terminal defined by claim 1, wherein the payment terminal is configured to transmit cash-back information to the sales device to at least one of (1) provide a cashier prompt to provide cash-back to the customer, (2) verify that an amount of the cash-back is correctly entered by the cashier, (3) provide a cashier prompt in response to an error in entry of the cash-back, and (4) verify that the amount of cash-back does not exceed the amount of debit card payments in the transaction.

19. The payment terminal defined by claim 1, wherein the payment terminal is configured to enable splitting the transaction into a plurality of payments using at least one of (1) cash, (2) a pre-paid card, (3) a check, (4) a coupon or discount entered by the cashier on the sales device, (5) authentication information, and (6) an account number entered directly to the payment terminal from a magnetic stripe card, a magnetically scanned card comprising EMV (Europay, Mastercard, Visa), contactless, NFC (near-field communication), or optically scanned two-dimensional or UPC (universal produce code) bar code, the payment terminal enabling separate recording of each payment on a single receipt and sending information to the sales device.

20. The payment terminal defined by claim 1, wherein the payment terminal or sales device in a foodservice facility is configured to display a table tab showing the total or detail and total plus tax and provide a customer prompt to enter a gratuity amount by selecting from at least one of (1) a choice of percentages, (2) leaving no gratuity, and (3) entering a gratuity amount or to print the table tab with the gratuity choices and prompt for customer signature before the transaction is authorized, thereby enabling a single authorization to submit the total, including gratuity, the payment terminal being configured to generate a complete receipt comprising a tab, tax, gratuity and total, thereby speeding service, eliminating a trip by a server, reducing table idle time, and eliminating a need for a second authorization requiring recall of the transaction and manual entry of the gratuity.

21. (canceled)

22. (canceled)

23. The payment terminal defined by claim 1, wherein the payment terminal is configured to provide a prompt to query whether a receipt is to be printed or electronically sent based on an amount of the transaction or customer preference indicated to or in the payment terminal.

24. (canceled)

25. The payment terminal defined by claim 20, wherein the payment terminal is battery-operated, wireless, and configured to be brought to the customer to complete the transaction by entering an account number and print a receipt showing the gratuity amount and total.

26. The payment terminal defined by claim 20, wherein the payment terminal is configured to at least one of (1) provide a prompt to enter an amount of the gratuity on the sales device and (2) provide a cashier prompt indicating that the gratuity amount entered into the sales device is incorrect.

27. (canceled)

28. The payment terminal defined by claim 1, wherein the payment terminal is configured to provide prompts to a plurality of customers to share in payment of the total tab, plus gratuity and added merchandise, the payment terminal being configured to provide separate receipts to each of the plurality of customers in equal or different shares to each customer.

29. The payment terminal defined by claim 1, wherein the payment terminal is configured to suppress printing of receipts associated with transactions not requiring a signature, the payment terminal being configured to notify the customer that no signature is required.

30. The payment terminal defined by claim 1, wherein the terminal is configured to recall a transaction from a transaction log to print or send an electronic receipt, the payment terminal being configured to authorize payment using a gift card based on available balance sufficiency associated with the gift card.

31. The payment terminal defined by claim 1, wherein the payment terminal is configured to refund in cash or other payment an available balance associated with a gift card in response to the available balance being less than a threshold, the payment terminal verifying that such refund is correctly entered into the sales device.

32. The payment terminal defined by claim 1, wherein the authorization request information comprises identification information associated with the payment terminal to enable verification that the payment terminal is correctly associated with a merchant.

33. The payment terminal defined by claim 1, wherein the payment terminal is configured to transmit cumulative transaction information to enable matching the cumulative transaction information with electronic payments approved by the payment authorization system, thereby enabling a plurality of transactions to be balanced.
